(19) United States
(12) Patent Application Publication
(10) Pub. No.: US 2005/0204790 A1
(43) Pub. Date: Sep. 22, 2005

(54) Lock core structure

(76) Inventor: Chun Te Yu, Fusing Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/126,200

(22) Filed: May 11, 2005

Related U.S. Application Data
(63) Continuation-in-part of application No. 10/671,659, filed on Sep. 29, 2003.

(30) Foreign Application Priority Data
Mar. 11, 2005 (TW) 094203872

(51) Int. Cl. E05B 27/04

(52) U.S. Cl. 70/493

(57) ABSTRACT

This invention relates to a lock core structure that can be rapidly installed in locks and prevent parts thereof from being detached. The lock core structure mainly comprises a sleeve, a shaft, plural lower pins, plural upper pins, a cover and plural springs. The sleeve has a channel therethrough. The sleeve has plural chambers in a wall thereof extending normal to an axis of the sleeve. The shaft is received within the channel. The shaft has a keyway with an opening for receiving the key to be driven by the key to rotate an angle to unlock the lock. The shaft has plural through holes corresponding to the chambers. Each of the lower pins has a cap secured in the through holes and a body extended from the cap, projectable into the keyway. Each of the plural upper pins is slidably received in the chambers, and deposed against each of the lower pins respectively. The cover covers the chambers and is secured to the sleeve. Each of the plural springs is deposed in the chambers with one end against each the plural upper pins and with another end against the cover.

### CROSS REFERENCE TO RELATED APPLICATION

This is a continuation-in-part application of the co-pending U.S. Ser. No. 10/671,659 application, filed on Sep. 29, 2003.

### TECHNICAL FIELD

This invention relates generally to a lock core structure, in particular, to provide a lock core structure that can be rapidly installed in locks.

### BACKGROUND OF THE INVENTION

Conventional lock core structures generally contain a sleeve, a shaft received in the sleeve. The convention lock core structures further contain plural lower pins and upper pins together with corresponding compression springs for securing or releasing the shaft to decide whether the shaft can be rotated to unlock the lock or not. However the conventional lock core has disadvantages such as it's difficult to assemble the lock core structure, the lower pins and upper pins are easily detached from the lock core structure during delivery thereof and the cost is high to produce the conventional lock core structure. Therefore, a lock core structure that can overcome the above-mentioned disadvantages is needed.

### SUMMARY OF INVENTION

It is therefore an objective of the present invention to provide a lock core structure that can be rapidly installed in locks and prevent parts thereof from being detached.

The present invention, briefly summarized, in one embodiment discloses a lock core structure installed in a lock for being operated by a key. The lock core structure mainly comprises a sleeve, a shaft, plural lower pins, plural upper pins, a cover and plural springs. The sleeve has a channel therethrough. The sleeve has plural chambers in a wall thereof extending normal to an axis of the sleeve. The shaft is received within the channel and has a keyway with an opening for receiving the key to be driven by the key to rotate an angle to unlock the lock. The shaft has plural through holes corresponding to the chambers. Each of the lower pins has a cap secured in the through holes and a body extended from the cap, projectable into the keyway. Each of the plural upper pins is slidably received in the chambers, and deposed against each of the lower pins respectively. The cover covers the chambers and is secured to the sleeve. Each of the plural springs is deposed in the chambers with one end against each of the plural upper pins and with another end against the cover. When the key is not inserted into the keyway, the plural upper pins are partially projected into the through holes of the shaft by the plural springs to secure the shaft and when the key is inserted into the keyway, the plural upper pins are pushed inwardly to be outside of the through holes, whereby the shaft can be rotated by the key to an angle to unlock the lock.

### BRIEF DESCRIPTION OF DRAWINGS

The invention will be more clearly understood after referring to the following detailed description read in conjunction with the drawings wherein:

FIG. 1 is an exploded view of the first embodiment of present invention to be engaged with a lock body;

FIG. 2 is a perspective view of the assembled first embodiment of present invention and to be inserted by a key;

FIG. 3 is a cross sectional view of the first embodiment of present invention wherein the lock is locked and the upper pins are projected by the spring partially into the through holes;

FIG. 4 is a cross sectional view of the first embodiment of present invention wherein the lock is unlocked by inserting the key and the upper pins are pushed inwardly by the key whereby the upper pins are outside of the through holes; and

FIG. 5 is an exploded view of the second embodiment of present invention.

### DETAILED DESCRIPTION OF PREFERRED EMBODIMENTS

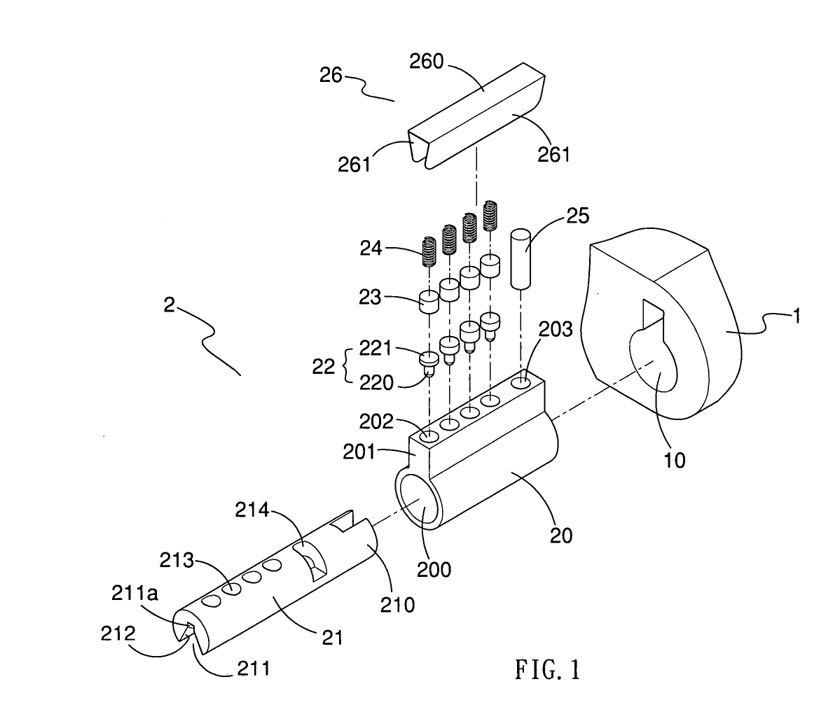

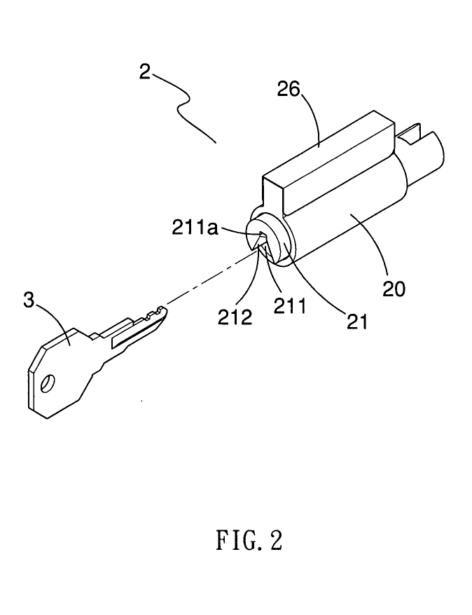

With reference to FIG. 1 and FIG. 2, the first embodiment of the present invention provides a lock core structure 2. The lock core structure 2 is installed in a lock 1 for being operated by a key 3 and mainly comprises a sleeve 20, a shaft 21, plural lower pins 22, plural upper pins 23, a cover 26 and plural springs 24. The sleeve 20 has a channel 200 therethrough. A wall of the sleeve 20 comprises an axial protrusion 201 extending from an exterior thereof in a radial direction. The plural chambers 202 are deposed within the axial protrusion 201 and extend normal to an axis of the sleeve 20. The cover 26 having two wings 261 for holding the axial protrusion 201 whereby the cover 26 covers the chambers 202 and secured to the sleeve 20. Preferably, the wings 261 of the cover 26 are formed by bending two sides of a plate body 260 respectively in order to have one wing 261 facing the other wing 261. The shaft 21 is received within the channel 200 and has a keyway 211 with an opening 211a for receiving the key 3 to be driven by the key 3 to rotate an angle to unlock the lock 1. The opening 211a of the keyway 211 has two guiding surfaces 212 at its two sides for guiding the key 3 being inserted into the keyway 211. The shaft 21 has plural through holes 213 corresponding to the chambers 202. Each of the lower pins 22 has a cap 221 secured in the through holes 213 and a body 220 extended from the cap 221, projectable into the keyway 211. The caps 221 of the lower pins 22 have various thicknesses. Each of the plural upper pins 23 is slidably received in the chambers 202, and deposed against each of the lower pins 22 respectively. Each of the plural springs 24 is deposed in the chambers 202 with one end against each the plural upper pins 23 and with another end against the cover 26.

With reference to FIG. 1, the sleeve 20 has a positioning hole 203. The shaft 21 has a positioning slot 214 along a periphery thereof corresponding to the positioning hole 203. A positioning plug 25 is deposed within the positioning hole 203 and extends into the positioning slot 214 for restraining axial movement of the shaft 21. The positioning slot 214 has a radial angle of approximate 90 degree for restraining rotation of the shaft within 90 degree.

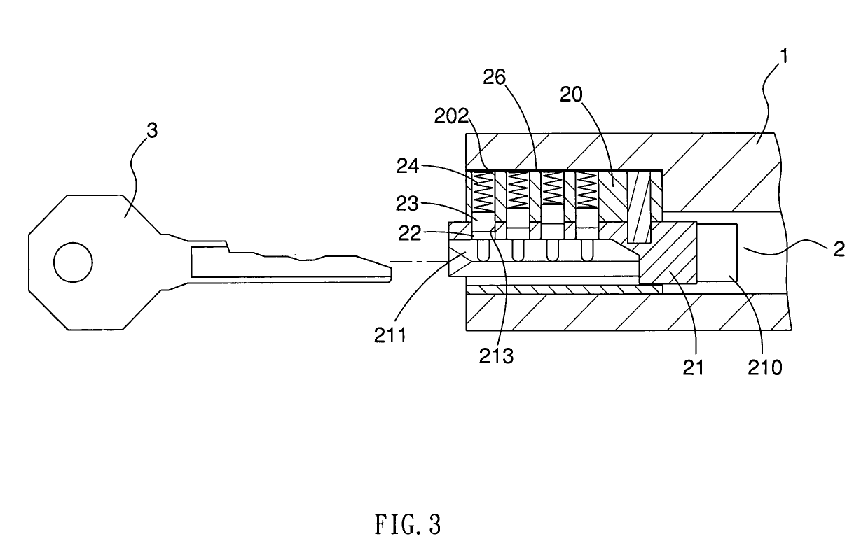

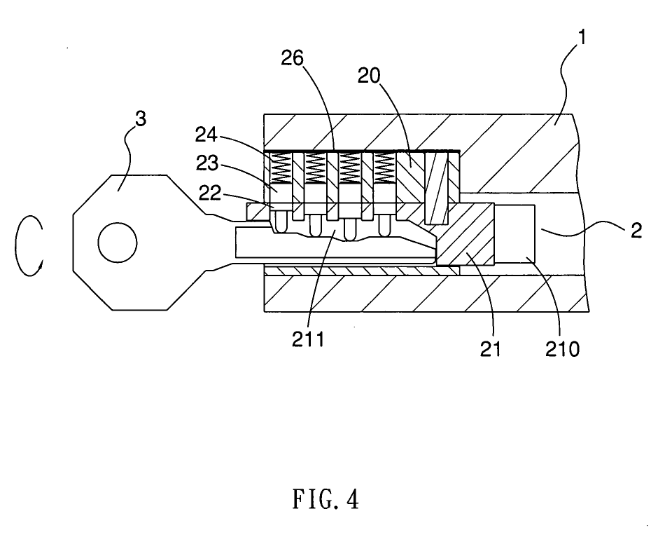

With reference to FIG. 3, when the key 3 is not inserted into the keyway 211, the plural upper pins 23 are partially projected into the through holes 213 of the shaft 21 by the plural springs 24 to secure the shaft 21. Referring to FIG. 4, when the key 3 is inserted into the keyway 211, the plural upper pins 23 are pushed inwardly to be outside of the through holes 213 and the top surface of the cap 221 is aligned with a periphery surface of the shaft 21, whereby the shaft 21 can be rotated by the key 3 guided by the positioning plug 25 in the positioning slot 214 to an angle without being blocked by the upper pins 23 to unlock the lock 1 through a driving end 210 of the shaft 21 extended from the sleeve 20.

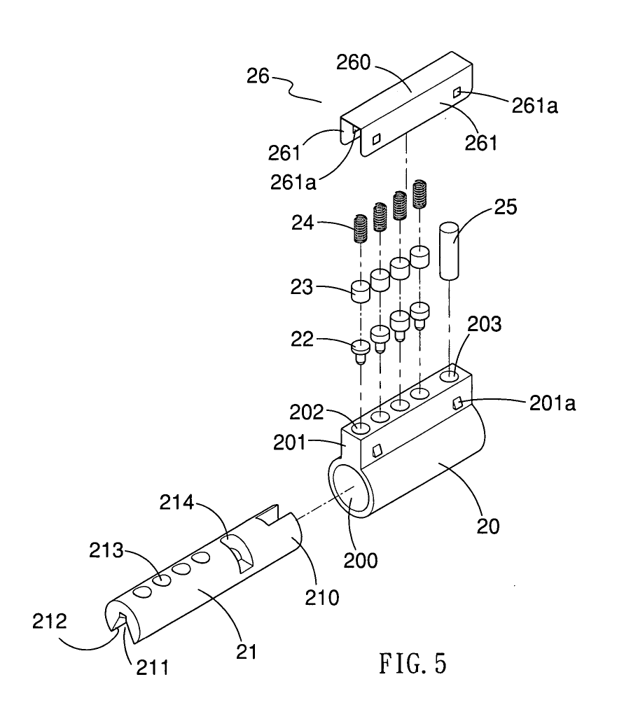

With reference to FIG. 5, the second embodiment of the invention has most of the material features of the first embodiment wherein in the second embodiment, the axial protrusion 201 having plural bumps 201a on its two lengthwise sides respectively and each of the two wings 261 of the cover 26 having plural openings 261a for being engaged with the plural bumps 201a respectively. Each of the plural bumps has an oblique slope for guiding each of the openings 261a of the wings 261 to be engaged with each of the plural bumps 201a.

The cover 26 of the lock core structure 2 in the present invention secure the lower pins 22, upper pins 23 and springs 24 within the sleeve 20 and shaft 21 whereby the lock core structure 2 can be rapidly installed in a lock 1 without the need to press the springs 24 to put the lock core structure 2 into the lock 1 and the cover can prevent the lower pins 22, upper pins 23 and springs 24 from falling out of the sleeve 20 and shaft 21.

In addition, in the first or second embodiments, the sleeve 20 and the shaft 21 are made of zinc alloy whereby the sleeves 20 and shaft 21 are suitable for being made through mold without the need for further machining and the lower pins 22 and upper pins 23 are made of copper.

Numerous characteristics and advantages of the invention have been set forth in the foregoing description, together with details of the structure and function of the invention, and the novel features thereof are pointed out in appended claims. The disclosure, however, is illustrated only, and changes may be made in detail, especially, in matters of shape, size and arrangement of parts, materials and the combination thereof within the principle of the invention, to the full extend indicated by the broad general meaning of the terms in which the appended claims are expressed.

1. A lock core structure installed in a lock for being operated by a key, said lock core structure comprising:
a sleeve has a channel therethrough, said sleeve having plural chambers in a wall thereof and extending normal to an axis of said sleeve;
a shaft received within said channel, said shaft having a keyway with an opening for receiving said key to be driven by said key to rotate an angle to unlock said lock, said shaft having plural through holes corresponding to said chambers;
plural lower pins, each of said lower pins having a cap secured in said through holes and a body extended from said cap, projectable into said keyway;
plural upper pins, each of said plural upper pins being slidably received in said chambers, and deposed against each of said lower pins respectively;
a cover covering said chambers and secured to said sleeve; and
plural springs, each of said plural springs being deposed in said chambers with one end against each said plural upper pins and with another end against said cover;
wherein when said key is not inserted into said keyway, said plural upper pins being partially projected into said through holes of said shaft by said plural springs to secure said shaft and when said key is inserted into said keyway, said plural upper pins are pushed inwardly to be outside of said through holes, whereby said shaft can be rotated by said key to an angle to unlock said lock.

2. The lock core structure of claim 1 wherein said sleeve has a positioning hole and said shaft has a positioning slot along a periphery thereof corresponding to said positioning hole, a positioning plug being deposed within said positioning hole and extending into said positioning slot.

3. The lock core structure of claim 1 where in said wall of said sleeve comprises an axial protrusion extending from an exterior thereof in a radial direction, said plural chambers being deposed within said axial protrusion, said cover having two wings for holding said axial protrusion.

4. The lock core structure of claim 1 wherein said wall of said sleeve comprises an axial protrusion extending from an exterior thereof in a radial direction, said plural chambers being deposed within said axial protrusion, said axial protrusion having plural bumps on its two lengthwise sides respectively, said cover having two wings, each of said two wings having plural openings for being engaged with each of said plural bumps respectively.

5. The lock core structure of claim 1 wherein said opening of said keyway has two guiding surfaces at its two sides for guiding said key being inserted into said keyway.

6. The lock core structure of claim 4 wherein each of said plural bumps has an oblique slope for guiding each of said openings of said wings to be engaged with each of said plural bumps.

7. The lock core structure of claim 6 wherein said sleeve and said shaft are made of zinc alloy and said lower pins and upper pins are made of copper.
